(19) United States
(12) Patent Application Publication
(10) Pub. No.: US 2008/0127247 A1
(43) Pub. Date: May 29, 2008

(54) METHOD AND SYSTEM FOR PLAYING MEDIA

(75) Inventors: Joel B. Allen, Mebane, NC (US); Joshua D. Ghiloni, Durham, NC (US); Wes Hayutin, Raleigh, NC (US); Howard S. Krovetz, Holly Springs, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,935

(22) Filed: Sep. 21, 2006

(51) Int. Cl. H04N 7/10

(52) U.S. Cl. 725/32

(57) ABSTRACT

A method for playing advertisement media and alternate media is disclosed. The method includes selecting the alternate media for playing, recognizing a beginning of playing of the advertisement media, and in response to the beginning of playing of the advertisement media, automatically beginning playing of the alternate media. The playing of the advertisement media and the alternate media each include at least one of audio media and video media, and the playing of the alternate media occurs simultaneous to the playing of the advertisement media. The playing of the alternate media overlays the advertisement media, such that only a marginal portion of the advertisement media is made available.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to media playback, and particularly to selection of media for playback.

2. Description of Background

Before our invention, a user of media content that includes advertisement media to which the user desires not to pay attention has been required to manually seek alternate media during the playback of the advertisement media. However, the process of manually seeking alternate media may consume time before the user finds alternate media of sufficient interest. Further, it may be possible to configure media playback equipment to prevent users from seeking alternate media during the playback of advertisement media. Accordingly, there is a need in the art for a media playback arrangement that overcomes these drawbacks.

### SUMMARY OF THE INVENTION

The shortcomings of the prior art are overcome and additional advantages are provided through the provision of a method and system to automatically overlay advertisement media with an alternate media of interest to the user.

An embodiment of the invention includes a method for playing advertisement media and alternate media. The method includes selecting the alternate media for playing, recognizing a beginning of playing of the advertisement media, and in response to the beginning of playing of the advertisement media, automatically beginning playing of the alternate media. The playing of the advertisement media and the alternate media each include at least one of audio media and video media, and the playing of the alternate media occurs simultaneous to the playing of the advertisement media. The playing of the alternate media overlays the advertisement media, such that only a marginal portion of the advertisement media is made available.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which enhances user time efficiency of media playback, and overcomes a blocking of the user to seek alternate media in response to an initiation of playback of advertisement media.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a media playback system in accordance with an embodiment of the invention.

FIG. 2 illustrates one example of a flowchart of a method for playing advertisement media and alternate media in accordance with an embodiment of the invention.

The detailed description explains the preferred embodiments of the invention, together with advantages and features, by way of example with reference to the drawings.

### DETAILED DESCRIPTION OF THE INVENTION

Often, advertisements are added to media content, and a user interested in the original media content is not interested in the content of the advertisement media. Users of media content frequently seek alternate media during the playback of such advertisement media. For example, if the advertisement is in the form of a commercial during a television show broadcast, via transmission towers or cable, the user may change the channel to observe a second television show for the duration of the commercial, and subsequently return to the original television show following the end of the commercial. Similarly, if the commercial is presented within a previously recorded media program, users may fast-forward to the end of the commercial to arrive at the media program. Methods to disable the response of broadcast and cable tuners to commands to change channel during advertisements may be developed to attempt to ensure that users view the advertisement media. Similarly, methods to disable the response of video recorders to commands to fast forward through the commercial may be developed to attempt to ensure that viewers view the advertisement media. Although such methods may be desirable to advertisers seeking to ensure that their advertisements are viewed, the methods may not be desirable to viewers that may want to minimize their viewing time to include only specific content.

In an embodiment of the invention, in response to detection of advertisement media, a customizable selection of media is overlaid on top of the advertisement, virtually removing the advertisement, both visually and audibly. In an embodiment, the customizable selection of media can be a variety of media, such as news clippings, and stock reports, for example. In another embodiment, the customizable selection of media can be small, customized programs, such as a work-out video or instructional “how-to” media, for example.

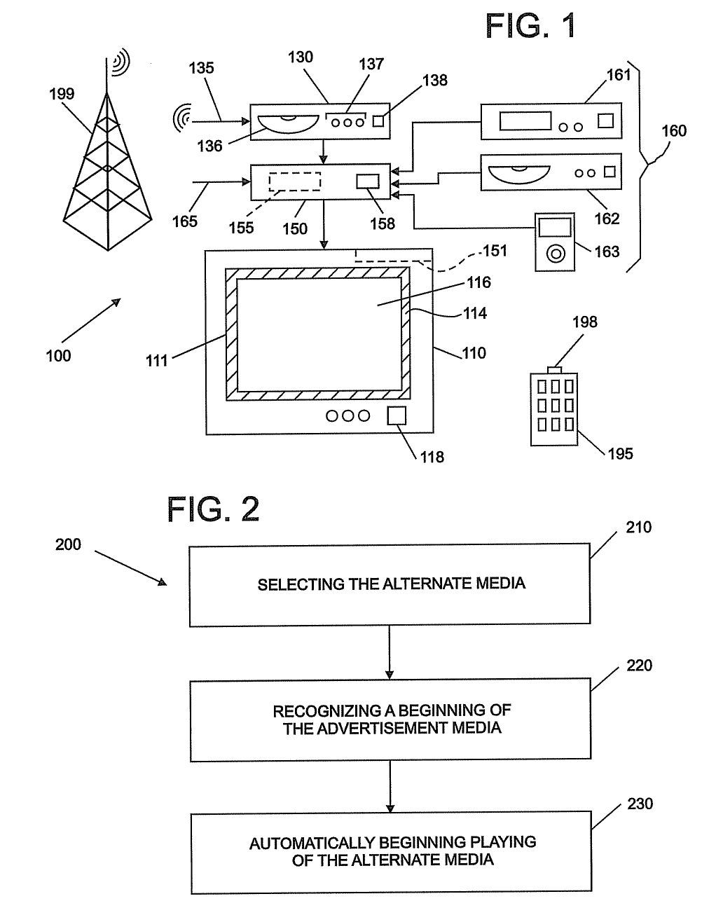

Referring now to FIG. 1, an exemplary embodiment of a media playback system 100 is depicted. The media playback system 100 includes a television (TV) 110, a primary media source 130, a media selection controller 150, and a remote control 195 in signal communication with at least one of the TV 110 and the primary media source 130. In an embodiment, the media selection controller 150 is incorporated, or integrated within the TV 110, as depicted by the hidden line 151.

The primary media source 130 is configured to provide to the TV 110 media content selected by the user. In an embodiment, the primary media source is configured to receive media via an incoming broadcast signal 135. In an embodiment, the incoming broadcast signal 135 is provided by a cable company, for example. In another embodiment, the incoming broadcast signal 135 is provided by an antenna configured to capture electromagnetic waves provided by transmission towers 199. In yet another embodiment, the incoming broadcast signal 135 is provided by a connection with the internet via a computer configured to store, arrange, and provide media content, the connection configured to provide media content to the primary media source 130. In another embodiment, the primary media source 130 is configured to play back previously recorded media 136. In an embodiment, the previously recorded media 136 content may be recorded via a digital versatile disc (DVD) 135, a videocassette, or upon a hard disk drive disposed within the primary media source 130.

While an embodiment of the invention has been described having a TV as a media playback device to allow the user to view the media content, it will be appreciated that the scope of the invention is not so limited, and that the invention will also apply to media playback systems 100 including other devices configured to play media, such as a personal media player, a cell phone configured to provide playback of media content, and a computer configured to provide playback of media content, for example.

The remote control 195 is configured to communicate with one or more of the TV 110, the primary media source 130, and the media selection controller 150. In an embodiment, an infrared transmitter 198 of the remote control 195 is configured to communicate with at least one infrared receiver 118, 138, 158 of the TV 110, primary media source 130, and media selection controller 150, respectively. As discussed above, the primary media source 130 may be configured to be unresponsive to commands, via either the remote control 195 or a set of local controls 137 disposed directly upon the primary media source 130, to change a channel of a plurality of channels of the incoming broadcast signal while advertisement media, provided by the primary media source 130, is being played. Further, as discussed above, the primary media source 130 may be configured to be unresponsive to commands, via either the remote control 195 or a set of local controls 137 disposed directly upon the primary media source 130, to fast forward through advertisement media included with the previously recorded media 136.

In an embodiment, the primary media source 130 is in signal communication with the TV 110 via the media selection controller 150. Accordingly, the signal from the primary media source 130 is provided first to the media selection controller 150 before being provided to the TV 110. In this way, the media selection controller 150 is configured to monitor the signal from the primary media source 130 for advertisement media, as will be described further below.

In an embodiment, the media selection controller 150 is also in signal communication with at least one secondary media source 160. In an embodiment, the secondary media source 160 is a video cassette player 161. In an embodiment, the secondary media source is a DVD player 162, or a DVD recorder 162, or a digital video recorder 162 configured to store media on a hard disk drive. In an embodiment, the secondary media source 160 is a personal media player 163. In another embodiment, the secondary media source 160 is an incoming signal 165 provided by a cable company, for example. In another embodiment, the incoming signal 165 is provided by an antenna configured to capture electromagnetic waves provided by transmission towers 199. In yet another embodiment, the incoming signal 165 is provided by a connection with the internet via a computer, the connection configured to provide media content to the media selection controller 150.

While an embodiment of the invention has been described with a variety of secondary media sources configured to store and play back media content, it will be appreciated that the above examples are intended for illustration, and not limitation, and that the scope of the invention will also apply to other secondary media sources that are configured to store and play back media content.

In an embodiment, the media selection controller 150 includes at least one electronic processing circuit 155. The electronic processing circuit 155 is configured to recognize a beginning of the advertisement media provided by the primary media source 130, and to control the secondary media source 160. In response to the electronic processing circuit 155 recognizing the beginning of playing the advertisement media, the secondary media source 160 is configured to automatically start making available to the TV 110 the alternate media provided by the secondary media source 160. That is, in response to the beginning of playing the advertisement media, the electronic processing circuit 155 is configured to initiate, or start, the playing of the alternate media.

In an embodiment, the user will select alternate media, as provided by the secondary media source 160 to be played instead of the advertisement media provided by the primary media source 130. For example, the user may insert a DVD into the DVD player 162 to be made available to the TV 110 in response to the detection of the advertisement media by the electronic processing circuit 155 of the media selection controller 150. In this way, the media selection controller 150 will allow the user to avoid the need to spend media viewing time viewing advertisements in which they are not interested, but will rather be able to maximize the use of media viewing time to view media that is of interest to the user. Further, it will be appreciated that selection, or specification by the user, of the alternate media will allow the user to avoid the need to spend media viewing time searching for alternate material that is desirable for viewing instead of advertisements, thereby allowing the user to maximize the use of media viewing time to view media that is of interest to the user.

In an embodiment, the electronic processing circuit 155 of the media selection controller 150 is configured to make available to the TV 110 the alternate media provided by the secondary media source 160 simultaneous with the advertisement media provided by the primary media source 130. In an embodiment, the media selection controller 150 is configured to overlay the alternate media over the advertisement media. Accordingly, the primary media source 130 continues to play the advertisement media at the same time that the secondary media source 160 plays the alternate media. As used herein, the term “overlay” is used to refer to the alternate media (video, audio, or both) being made available to the user in place of, or along with, the advertisement media. For example, in the embodiment of the TV 110 media playback device, almost all of a display screen 111 of the TV 110 will display the alternate media, and only a small portion of, or a marginal portion of, the display screen 111 will display the advertisement media. As depicted in FIG. 1, it will be appreciated that the advertisement media, which is played simultaneously with the alternate media, is depicted by the small hatched area indicated by reference numeral 114. Likewise, it will be appreciated that the alternate media is depicted by the large area indicated by reference numeral 116. In this way, even though the user may be prevented from changing a channel or fast forwarding to avoid the advertisement media, the user will be able to essentially replace the advertisement media with alternate media which is desirable to the user. Accordingly, in an embodiment, only a marginal portion of the audio corresponding to the video of the advertisement media will be made available to the user. In a similar manner, if the advertisement media and alternate media are audio media, the electronic processing circuit 155 is configured to adjust the volume, or intensity, of the advertising media provided by the primary media source 130 relative to the alternate media made available by the secondary media source 160 such that a user hears only a marginal portion, of the advertisement media.

While an embodiment of the invention has been described having only a small portion of the advertisement media made available to the user via the TV 110, it will be appreciated that the scope of the invention is not so limited, and that the invention will also apply to media playback systems having other arrangements of the alternate media relative to the advertising media, such as the alternate media fully covering the advertisement media, and the alternate media equally sharing the display screen of the TV, for example. Further, while an embodiment of the invention has been described having the alternate media overlay the advertisement media such that only a marginal portion of the audio is made available to the user, it will be appreciated that the scope of the invention is not so limited, and that the invention will also apply to media playback systems having other arrangements of the audio of the alternate media relative to the advertisement media, such as providing the audio from the alternate media having the same intensity, or volume, as the advertisement media, for example. In an embodiment, the media selection controller 150 is configured to allow user selection of the arrangement of the alternate media relative to the advertisement media.

In an embodiment, the electronic processing circuit 155 of the media selection controller 150 is configured to recognize an end of the advertisement media provided by the primary media source 130, and to control the secondary media source 160 in response to the end of the advertisement media. For example, the media selection controller 150 is capable to determine when the commercial, as part of the media program, has ended. In an embodiment, the secondary media source 160 is configured to automatically end, or stop, the making available of the alternate media simultaneously with the advertisement media in response to the electronic processing circuit 155 of the media selection controller 150 recognizing the end of the advertisement media. For example, when the commercial, as part of the media program, has ended, the media selection controller 150 will control the secondary media source 160 to cease playback of the alternate media. Further, the media selection controller 150 will provide to, or display on, the TV 110 the original media program provided by the primary media source 130 that included the commercial. In an embodiment, the alternate media includes at least one of audio media and video media. In an embodiment, the advertisement media includes at least one of audio media and video media.

In view of the foregoing, the media playback system 100 performs the method of playing advertisement media and alternate media. Referring now to FIG. 2, an exemplary flowchart 200 of an embodiment of the method to play advertisement media and alternate media is depicted.

The method begins with selecting 210 the alternate media for playing by the secondary media source 160, and includes recognizing 220 the beginning of playing of the advertisement media by the primary media source 130. In response to the beginning of playing of the advertisement media, automatically beginning 230 playing of the alternate media by the secondary media source 160. In an embodiment, the playing of the alternate media occurs simultaneous to the playing of the advertisement media, and the playing of the alternate media overlays the advertisement media on the TV 110, such that only a marginal portion of the advertisement media is played, or made available to the user. In an embodiment, the playing of the alternate media is according to the user selected arrangement of the alternate media relative to the advertisement media.

In an embodiment, the method further includes recognizing the end of playing of the advertisement media by the primary media source 130. In an embodiment, in response to the end of playing of the advertisement media, automatically ending the playing of the alternate media by the second media source 160, to resume display of the original media program, by the primary media source 130, on the TV 110.

In an embodiment, the playing of the advertisement media includes playing of the advertisement media made available by one of the broadcast media source 135, the cable media source 135, the digital versatile disc player 130, the digital video recorder 130, and the personal media player 130, and playing one of audio media and video media. In an embodiment, the playing of the alternate media includes playing the alternate media made available by one of the videocassette recorder 161, the digital versatile disc player 162, the digital video recorder 162, and the personal media player 163, and playing at least one of audio media and video media.

The capabilities of the present invention can be implemented in software, firmware, hardware or some combination thereof.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for playing advertisement media and alternate media, the method comprising:
selecting the alternate media for playing;
recognizing a beginning of playing of the advertisement media; and
in response to the beginning of playing of the advertisement media, automatically beginning playing of the alternate media;
wherein the playing of the advertisement media comprises at least one of audio media and video media;
wherein the playing of the alternate media comprises at least one of audio media and video media;
wherein the playing of the alternate media occurs simultaneous to the playing of the advertisement media; and
wherein the playing of the alternate media overlays the advertisement media, such that only a marginal portion of the advertisement media is played.

2. The method of claim 1, wherein the playing of the alternate media overlays the advertisement comprises:
playing of the alternate media according to a user selected arrangement of the alternate media relative to the advertisement media.

3. The method of claim 1, further comprising:
recognizing an end of playing of the advertisement media.

4. The method of claim 3, wherein:
in response to the end of playing of the advertisement media, automatically ending the playing of the alternate media.

5. The method of claim 1, wherein the playing the alternate media comprises:
playing the alternate media made available by one of a videocassette recorder, a digital versatile disc player, a digital video recorder, and a personal media player.

6. The method of claim 1, wherein the recognizing the beginning of playing of the advertisement media comprises:
playing of the advertisement media made available by one of a broadcast media source, a cable media source, a digital versatile disc player, a digital video recorder, and a personal media player.

7. A program storage device readable by an electronic circuit, the device embodying a program or instructions executable by the electronic circuit to perform the method of claim 1.

8. A media selection system for playing advertisement media and alternate media, the system comprising:
means for making available the advertisement media;
means for making available the alternate media; and
a media selection controller comprising:
means for recognizing a beginning of the advertisement media; and
means for controlling the means for making available the alternate media in response to the beginning of the advertisement media;
wherein in response to the media selection controller recognizing a beginning of the advertisement media, the means for making available the alternate media is configured to automatically start making available the alternate media simultaneous with the advertisement media; and
wherein the media selection controller is configured to overlay the alternate media over the advertisement media, such that only a marginal portion of the advertisement media is made available.

9. The system of claim 8, wherein:
the media selection controller is configured to allow user selection of the arrangement of the alternate media relative to the advertisement media.

10. The system of claim 8, further comprising:
means for playback of the advertisement media and the alternate media.

11. The system of claim 10, wherein:
the media selection controller is integrated within the means for playback.

12. The system of claim 8, wherein the media selection controller further comprises:
means for recognizing an end of the advertisement media; and
means for controlling the means for making available the alternate media in response to the end of the advertisement media.

13. The system of claim 12, wherein:
in response to the media selection controller recognizing the end of the advertisement media, the means for making available the alternate media is configured to automatically stop making available the alternate media simultaneous with the advertisement media.

14. The system of claim 8, wherein:
the advertisement media comprises at least one of audio media and video media.

15. The system of claim 8, wherein:
the alternate media comprises at least one of audio media and video media.
